(19) United States
(12) Patent Application Publication
(10) Pub. No.: US 2002/0004449 A1
(43) Pub. Date: Jan. 10, 2002

(54) Process for producing a catalyst body, and catalyst body

(76) Inventor: Erich Hums, Hessdorf (DE)

Correspondence Address: LERNER AND GREENBERG, P.A., Post Office Box 2480, Hollywood, FL, 33020-2480, US

(21) Appl. No.: 09/894,678

(22) Filed: Jun. 28, 2001

Related U.S. Application Data
(63) Continuation of application No. PCT/DE99/03996, filed on Dec. 15, 1999.

(30) Foreign Application Priority Data
Dec. 28, 1998 (DE) 198 60 495.5

(51) Int. Cl. B01J 23/38; B05D 3/02; B05D 1/08

(52) U.S. Cl. 502/245; 502/332; 502/333; 502/334; 502/261; 502/262; 427/376.2; 427/453

(57) ABSTRACT

A process for producing a catalyst body includes spraying an aluminum hydroxide and a metallic aluminum simultaneously but separately onto a support body. In the process, the aluminum hydroxide is thermally converted into an aluminum oxide. In addition, an aluminum/silicon compound is thermally sprayed onto the support body at the same time as but separately from the metallic aluminum, and a metallic active component is supplied. Such a catalyst body produced is suitable, in particular, for breaking down pollutants in a temperature range that lies above 400° C. A catalyst body includes the support body and an active compound thermally sprayed thereon. The active compound includes metallic aluminum, an aluminum oxide, an aluminum/silicon compound, and a metallic active component. The active compound is produced by the separate and simultaneous thermal spraying of the metallic aluminum and the aluminum/silicon compound.

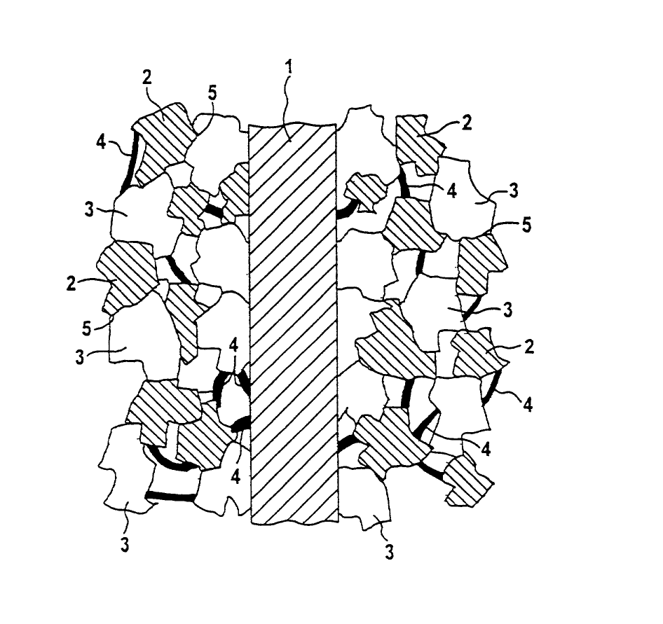

### CROSS-REFERENCE TO RELATED APPLICATION

This application is a continuation of copending International Application No. PCT/DE99/03996, filed Dec. 15, 1999, which designated the United States.

### BACKGROUND OF THE INVENTION

### FIELD OF THE INVENTION

The invention relates to a process for producing a catalyst body with an active compound on a support body by thermal spraying. An aluminum hydroxide and a metallic aluminum are thermally sprayed separately but simultaneously onto the support body, and the aluminum hydroxide is thermally converted into an aluminum oxide. The invention also relates to a catalyst body having an active compound produced by thermal spraying on a support body, the active compound includes metallic aluminum and aluminum oxide.

Relevant processes and catalysts are disclosed in German Patent DE 196 24 923 C1, corresponding to U.S. Pat. No. 6,228,801 to Hums et al. The simultaneous thermal spraying of aluminum hydroxide and metallic aluminum causes chemically bonded microparticles to form during the spraying operation and in the adhesion compound that is deposited on the support body. The conversion takes place as a result of the introduction of heat during the thermal spraying. However, the complete conversion into an aluminum oxide can also be achieved by a heat treatment taking place after the spraying operation or by a calcining process. The aluminum that is sprayed simultaneously acts as a composite material. During the spraying operation, the softened aluminum flows around the other sprayed components and contributes to them adhering to one another and to the support body. As a result of the simultaneous spraying of aluminum hydroxide and metallic aluminum, the adhesion compound that is formed on the support body has a high specific surface area and is, therefore, particularly suitable for a catalyst body. Moreover, the adhesion compound that is formed is fixedly and permanently joined to the support body by the aluminum and the aluminum oxide. On account of its high specific surface area, the actual spraying operation is relatively short, so that even with thin support bodies, i.e., with a support body of a thickness of less than 1 mm, there is no distortion during the spraying operation.

Prior art examples of an aluminum hydroxide are a gibbsite (monoclinic γ-Al(OH)₃) or a boehmite (rhombic crystalline metahydroxide γ-Al (OH)). An aluminum oxide is formed from these materials by the removal of water.

The term thermal spraying is understood as meaning both plasma spraying and flame spraying. In both processes, the sprayed components are supplied in powder form in a conventional manner to a spray nozzle and are sprayed onto the support body in a more or less molten form as a result of heating.

Metal oxides, in particular titanium dioxide, tungsten trioxide and molybdenum trioxide, are disclosed from German Patent DE 196 24 923 C1 as active components for producing the catalytic activity of the adhesion compound, which is then referred to as an active compound. The metal oxides are either sprayed on directly or are formed during the spraying operation.

A drawback that has emerged is that such a catalyst body cannot be used for applications in a temperature range above 400° C. Particularly when the catalyst body is used to break down pollutants in a gaseous medium, such as, for example, in an exhaust gas of a combustion installation, the conversion rate deteriorates significantly at temperatures of over 400° C. Such deterioration appears to be that the pollutants to be converted can no longer be adsorbed on the active compound at these temperatures, yet such adsorbtion is a basic precondition for the catalytic conversion of the pollutant. As such, such a catalyst body is also unsuitable for use as a deNOx catalytic converter that uses the selective catalytic reduction (SCR) process to convert nitrogen oxides, in the presence of oxygen, into nitrogen by a suitable reducing agent, at temperatures of over 400° C. An additional factor in the SCR process is that the reducing agent additionally has to be adsorbed on the active compound to convert the nitrogen oxides.

Because of the drawbacks outlined above, zeolite-based catalyst bodies that have to be produced in a conventional way by producing a slurry of the active compound followed by shaping or coating of a support body, with a final calcining process, have gained widespread acceptance. It has not hitherto been possible to utilize the advantages of production by thermal spraying.

### SUMMARY OF THE INVENTION

It is accordingly an object of the invention to provide a process for producing a catalyst body that overcomes the hereinafore-mentioned disadvantages of the heretofore-known devices and methods of this general type and that is suitable even for applications in the temperature range of over 400° C. by thermal spraying. The invention further provides a catalyst body that has an active compound produced by thermal spraying and that is also suitable for applications in a temperature range of over 400° C.

With the foregoing and other objects in view, there is provided, in accordance with the invention, a process for producing a catalyst body with an active compound on a support body by thermal spraying including the steps of thermally spraying an aluminum hydroxide and an aluminum/silicon compound separately from and simultaneously with metallic aluminum onto a support body, supplying a metallic active component, and thermally converting the aluminum hydroxide into an aluminum oxide to form an active compound at the support body.

The invention describes a process for producing a catalyst body with an active compound on a support body by thermal spraying. An aluminum hydroxide and metallic aluminum are thermally sprayed separately and simultaneously onto the support body, and the aluminum hydroxide is thermally converted into an aluminum oxide. According to the invention, an aluminum/silicon compound is thermally sprayed onto the support body separately from but at the same time as the metallic aluminum, and a metallic active component is supplied, thus, forming the active compound.

The invention is based on the discovery that an aluminum/silicon compound, in the presence of a metallic active component with a correspondingly high specific surface area, forms a catalytically active compound that is suitable for catalyzing a desired reaction even in a temperature range of over 400° C. One example is what are referred to as zeolites, i.e., crystalline framework aluminosilicates with characteristic micropores, which are known to have a high ability to adsorb pollutants, such as, for example, dioxins/furans or nitrogen oxides. The doping of a zeolite with a metal creates a highly reactive active compound. However, an aluminum/silicon compound with a suitably high specific surface area would lose the high specific surface area in a conventional thermal spraying operation due to the temperatures of in some cases over 1000° C., as a result of at least partial melting.

However, if, at the same time as the aluminum/silicon compound, an aluminum hydroxide and, separately and simultaneously, metallic aluminum are thermally sprayed, a loss of specific surface area as a result of melting is prevented. In fact, extensive tests have shown that, with such a spraying operation, the particles of the aluminum/silicon compound are apparently at least partially enclosed by particles of aluminum oxide that is formed and of metallic aluminum. It is possible that, in the presence of oxygen, an aluminum oxide also forms from the metallic aluminum, the oxide bonding to the aluminum oxide formed from the aluminum hydroxide and, as such, enclosing the particles of the aluminum/silicon compound. Other chemical bonds or adhesion forces could also be responsible for the effect.

The partial enclosure by metallic aluminum and by aluminum oxide protects the aluminum/silicon compound from the effects of temperature. Because, moreover, with such a spraying operation a material that adheres well to the support body and has a high specific surface area is formed, the duration of the spraying operation is also relatively short. Accordingly, the protected aluminum/silicon compound is substantially not melted during the thermal spraying, and, consequently, only loses its specific surface area to a negligible extent.

As a result of supplying a metallic active component, an active compound is produced. In accordance with another mode of the invention, the production may advantageously be effected by doping the aluminum/silicon compound with the metallic active component prior to the thermal spraying. Such doping can take place in a conventional manner. It is also possible for the metallic active component to have been prepared as early as during the synthesis of the aluminum/silicon compound. The latter procedure is recommended, in particular, if the aluminum/silicon compound used has a relatively small pore diameter.

The thermal spraying operation may take place in an oxygen-containing atmosphere or in air. Such an environment, on one hand, promotes the conversion of the aluminum hydroxide into an aluminum oxide and, on the other hand, also promotes the partial conversion of aluminum into aluminum oxide. These characteristics, in principle, increase the linking of the compound applied to the support body.

The metallic aluminum may also be an alloy of aluminum.

In accordance with a further mode of the invention, the metallic active component may preferably also be supplied by impregnating the compound applied to the support body with the metallic active component. Such supplying may be achieved, for example, by immersing the catalyst body in a solution of the metallic active component, and subsequently drying and calcining. As such, the metallic active components may be dissolved in the form of their nitrates.

In accordance with an added mode of the invention, a precious metal is a suitable metallic active component for producing a high catalytic activity in an aluminum/silicon compound. A particularly good catalytic activity can be achieved by platinum (Pt), palladium (Pd), rhodium (Rh), or a mixture of the above mentioned metals.

In accordance with an additional mode of the invention, the aluminum hydroxide and the aluminum/silicon compound are processed to form a powder mixture prior to the spraying operation and are jointly thermally sprayed onto the support body. The configuration ensures that chemical bonds are formed between the aluminum hydroxide (that is partially and gradually converted into an aluminum oxide) and the aluminum/silicon compound as early as during the spraying operation. As such, the aluminum/silicon compound can be protected to an even greater extent from the effect of heat during the thermal spraying.

Particularly if the powder of the aluminum/silicon compound that is to be sprayed is very fine or in dust form, and, therefore, the nozzle used becomes blocked, it is recommended in accordance with yet another mode of the invention for the aluminum/silicon compound and the aluminum hydroxide to be processed to form a powder mixture such that particles of the aluminum/silicon compound are agglomerated with particles of the aluminum hydroxide. The agglomeration or the wetting of the aluminum/silicon compound with the aluminum hydroxide produces a free-flowing powder mixture that can easily be thermally sprayed. The wetting, in turn, allows chemical bonds to form as early as during the spraying operation.

In accordance with yet a further mode of the invention, the catalyst body is advantageously subjected to a heat treatment, preferably after the thermal spraying. On one hand, the treatment allows complete conversion of the aluminum hydroxide into the aluminum oxide by extraction of water, thus, providing additional hardening, and, on the other hand, enables the catalytic activity to be increased when the active compound is subjected to the heat treatment. Overall, the adhesion of the active compound to the support body is also improved. The heat treatment may also be a calcining process.

Expediently, in accordance with yet an added mode of the invention, an aluminum/silicon compound with a higher atomic percentage of silicon than aluminum is thermally sprayed. Such an aluminum/silicon compound, due to its high silicon content, is distinguished by a very good resistance to heat. Using such an aluminum/silicon compound has the advantage that, firstly, the specific surface area is not reduced during the spraying operation and, secondly, that the aluminum/silicon compound in the active compound does not undergo any change in its materials properties even when the catalyst body is utilized for a prolonged period in a temperature range of over 400° C. It is recommended, in particular, to select an aluminum/silicon compound that is able to withstand long-term temperature loads of over 700° C., i.e., is thermally stable without a change in structure in terms of the specific surface area and the pore volume at these temperatures.

The wetting may, for example, be effected by dripping a dissolved aluminum hydroxide onto the aluminum/silicon compound, which is in powder form, with continuous mixing.

The aluminum/silicon compound that is thermally sprayed is preferably an aluminosilicate. These aluminosilicates are known to be catalytically suitable and to be relatively good at withstanding high temperatures. A particularly suitable aluminosilicate is a zeolite, i.e., a framework aluminosilicate that, due to its defined lattice structure, has characteristic micropores of the order of magnitude of gas molecules. Zeolites have a high specific surface area of, in particular, between 800 and 1000 m²/g and a high adsorption capacity for gas molecules. For a definition of zeolites, reference should be made to Römpps Chemie-Lexikon, Franckh'sche Verlagshandlung, Stuttgart 1988, 8th edition, pages 4690 to 4691, and to Kirk-Othmer, “Encyclopedia of Chemical Technology”, 3rd edition, volume 15, John Wiley & Sons, New York, 1981, pages 640 to 669. Particularly suitable zeolites are the naturally occurring mineral mordenite, a ZSM-5 zeolite, an H-zeolite, a USY-zeolite, or a beta zeolite. For a definition of these zeolites, reference is made to the specialist article “Acidität der Lewis-Zentren in Zeolith-Katalysatoren—NO als Sondenmolekül” [Acidity of the Lewis centers in zeolite catalysts—NO as probe molecule] by Frank 0. Witzel in Fortschrittberichte VDI, series 3: Verfahrenstechnik, No. 292. Particularly when doped with platinum, palladium, or rhodium, such a zeolite, in particular, an acid zeolite, has a high catalytic activity for the conversion of nitrogen oxides from a gaseous medium using the SCR process. A catalyst body that is produced using such a zeolite is, therefore, particularly suitable as a high-temperature deNOx catalyst for reducing the levels of nitrogen oxides in the exhaust gas from a combustion installation. One example application is the use for the reduction of nitrogen oxides in the exhaust gas from a gas turbine, which can easily reach high temperatures of up to over 450° C. It is possible to eliminate the need to cool the exhaust gas by a heat recovery steam generator.

A copper/silicon aluminophosphate also has a high catalytic activity.

With the objects of the invention in view, there is also provided a catalyst body includes a support body and a thermally sprayed on active compound thermally sprayed on the support body. The active compound includes thermally sprayed on metallic aluminum, an aluminum oxide and, in addition, according to the invention a thermally sprayed on aluminum/silicon compound and a metallic active component. The active compound is produced by separate and simultaneous thermal spraying of the metallic aluminum and the aluminum/silicon compound.

By thermally spraying the components of the active compound, a to structurally different catalyst body is produced when compared with a compound that is provided by dipping, for example, or any other application method.

Such a catalyst body is particularly suitable for any applications in a temperature range of over 400° C. Due to its excellent ability to withstand high temperatures, there is no expectation of any loss in catalytic activity even over a prolonged operating period.

Particularly for applications for breaking down pollutants in a gaseous medium, the catalyst body may be in the form of a plate-type catalyst through which the medium can flow. Naturally, any other configurations are also conceivable. Depending on the type of metallic active component and the type of aluminum/silicon compound, the catalyst body can be used to break down a very wide range of pollutants, such as, for example, dioxins/furans, nitrogen oxides, or carbon monoxide.

In accordance with yet an additional feature of the invention, the aluminum oxide and the aluminum/silicon compound are substantially separate microparticles, and the microparticles are crosslinked to one another by the metallic aluminum.

In accordance with again another feature of the invention, the microparticles are additionally joined to one another by oxygen binding.

In accordance with again a further feature of the invention, the metallic active component is incorporated in the aluminum/silicon compound.

In accordance with again an added feature of the invention, the metallic active component is a precious metal. The catalyst body has a particularly high catalytic activity with regard to breaking down nitrogen oxides using the SCR process if the precious metal, in particular, platinum Pt, palladium Pd, rhodium Rh, or a mixture thereof is used as the metallic active component.

Due to the high specific surface area and the high adsorption capacity for gas molecules, it is advantageous, if, in accordance with again an additional feature of the invention, the catalyst body is to be used in gaseous media, if the aluminum/silicon compound is an aluminosilicate, in particular, a zeolite.

In accordance with still another feature of the invention, the zeolite is selected from the group consisting of a mordenite, a ZSM-5 zeolite, an H-zeolite, a USY-zeolite, and a beta zeolite.

In accordance with a concomitant feature of the invention, the aluminum/silicon compound is a copper/silicon aluminophosphate.

It is particularly expedient for the catalyst body if the support body has a thickness of less than 1 mm, preferably, less than 100 μm. As such, it is possible to save material for the support body compared to a conventional catalytic converter.

The support body itself may be made of a metal or a ceramic. The support body may be of any desired structure, for example, in the form of a plate, a strip, a rod, or a tube. The support body may also be a honeycomb. A chromium/aluminum steel is a particularly advantageous material for the support body. Such a support body can be used to achieve a high service life of the catalyst body.

For improved adhesion of the adhesion compound or the active compound to the support body, the support body may be mechanically or chemically roughened.

Other features that are considered as characteristic for the invention are set forth in the appended claims.

Although the invention is illustrated and described herein as embodied in a process for producing a catalyst body and a catalyst body, it is, nevertheless, not intended to be limited to the details shown because various modifications and structural changes may be made therein without departing from the spirit of the invention and within the scope and range of equivalents of the claims.

The construction and method of operation of the invention, however, together with additional objects and advantages thereof, will be best understood from the following description of specific embodiments when read in connection with the accompanying drawings.

### BRIEF DESCRIPTION OF THE DRAWING

The FIGURE is a cross section through a catalyst body according to the invention that is produced by thermal spraying and is able to withstand high temperatures.

### DESCRIPTION OF THE PREFERRED EMBODIMENTS

To produce the catalyst body according to the invention, a powder of aluminum and a powder mixture of boehmite, gibbsite, and an acid ZSM-5 zeolite with a silicon to aluminum oxide ratio of 23.3 are used. The aluminum powder has a mean particle size of less than 30 μm. To produce the powder mixture of boehmite, gibbsite, and the ZSM-5 zeolite, the fine-grained powder of the ZSM-5 zeolite is wetted with the boehmite and gibbsite components. The result is a free-flowing powder of the powder mixture. The percentage by mass of the aluminum is 8%, the percentage by mass of the boehmite is 26%, the percentage by mass of the gibbsite is 16.5%, and the percentage by mass of the doped ZSM-5 zeolite is 49.5%. The ZSM-5 zeolite is doped with the metallic active component platinum.

The metallic aluminum is thermally sprayed at the same time as and separately from the powder mixture of boehmite, gibbsite, and the ZSM-5 zeolite. The compound that is sprayed on is subjected to a final calcining operation to achieve final dewatering and activation of the active compound. The active compound has a BET surface area of 60 to 70 m²/g.

Referring now to the single figure of the drawing, it is seen that the support body 1 of the catalyst body is a chromium/aluminum steel in the form of a plate that is 40 μm thick. The support body 1 is coated with the active compound on both sides by thermal spraying. The surface of the support body 1 is not shown in more detail in the figure, but may be it roughened, for example, by a mechanical or chemical treatment. The deformation on impact causes the aluminum oxide 3 to adhere to the support body 1 as a result of adhesion forces. The separately sprayed, metallic aluminum 4 acts as a bonding material and links the individual catalytically active components to one another and also links the active compound to the support body 1. The microparticles of the aluminum oxide 3 and the ZSM-5 zeolite 2 can be seen clearly. The microparticles of the ZSM-5 zeolite 2 are surrounded by the microparticles of the aluminum oxide 3 and are chemically bonded thereto both directly and through the aluminum 4. The surrounding of the microparticles of the ZSM-5 zeolite by aluminum 4 and by particles of aluminum oxide 3 during the spraying operation can no longer be seen as clearly, due to the impact on the support body 1. The locations where the aluminum oxide 3 is chemically bonded to the ZSM-5 zeolite 2 are denoted by the reference numeral 5.

The active compound of the catalyst body has a high resistance to abrasion due to the chemical bonds between the aluminum oxide 3 and the ZSM-5 zeolite 2 and due to the aluminum 4 acting as a bonding material.

The ZSM-5 zeolite is doped with the metallic active component platinum such that the component is incorporated in the micropores of the ZSM-5 zeolite. The metallic active component platinum is not shown in more detail in the figure.

The catalyst body illustrated is suitable for breaking down nitrogen oxides using the SCR process in a gaseous medium. The catalyst body is distinguished by an excellent ability to withstand high temperatures and is, therefore, particularly suitable for applications in a temperature range of over 400° C. It is, therefore, intended, for example, for use as a deNOx catalytic converter in a hot exhaust gas from a combustion installation. One example of such a combustion installation is a gas turbine. It is no longer necessary to cool the hot exhaust gas as is required for the use of conventional deNOx catalytic converters.

I claim:

1. A process for producing a catalyst body with an active compound on a support body by thermal spraying, which comprises:
thermally spraying an aluminum hydroxide and an aluminum/silicon compound separately from and simultaneously with metallic aluminum onto a support body;
supplying a metallic active component; and
thermally converting the aluminum hydroxide into an aluminum oxide to form an active compound at the support body.

2. The process according to claim 1, which further comprises performing the supplying step by doping the aluminum/silicon compound with the metallic active component prior to the thermal spraying.

3. The process according to claim 1, further comprises performing the supplying step by supplying the metallic active component by impregnation.

4. The process according to claim 2, wherein the metallic active component is a precious metal.

5. The process according to claim 4, wherein the precious metal is selected from the group consisting of Pt, Pd, Rh, and mixture of at least two of Pt, Pd, and Rh.

6. The process according to claim 1, wherein the metallic active component is a precious metal.

7. The process according to claim 6, wherein the precious metal is selected from the group consisting of Pt, Pd, Rh, and mixture of at least two of Pt, Pd, and Rh.

8. The process according to claim 1, which further comprises:
processing the aluminum hydroxide and the aluminum/silicon compound to form a powder mixture; and
thermally spraying the aluminum hydroxide and the aluminum/silicon compound together onto the support body.

9. The process according to claim 8, which further comprises performing the processing step by processing the aluminum/silicon compound and the aluminum hydroxide to form the powder mixture such that particles of the aluminum/silicon compound are agglomerated with particles of the aluminum hydroxide.

10. The process according to claim 1, which further comprises heat treating after the thermal spraying.

11. The process according to claim 1, which further comprises performing the thermally spraying step by thermally spraying an aluminum/silicon compound having a higher atomic proportion of silicon than of aluminum.

12. The process according to claim 1, wherein the aluminum/silicon compound is an aluminosilicate.

13. The process according to claim 12, wherein the aluminosilicate is a zeolite.

14. The process according to claim 13, wherein the zeolite is selected from the group consisting of a mordenite, a ZSM-5 zeolite, an H-zeolite, a USY-zeolite, and a beta zeolite.

15. The process according to claim 1, wherein the aluminum/silicon compound is a copper/silicon aluminophosphate.

16. A catalyst body, comprising:
a support body;
a thermally sprayed on active compound thermally sprayed on said support body, said active compound including:
thermally sprayed on metallic aluminum;
an aluminum oxide;
a thermally sprayed on aluminum/silicon compound; and
a metallic active component; and
said active compound being produced by separate and simultaneous thermal spraying of said metallic aluminum and said aluminum/silicon compound.

17. The catalyst body according to claim 16, wherein:
said aluminum oxide and said aluminum/silicon compound are substantially separate microparticles; and
said microparticles are crosslinked to one another by said metallic aluminum.

18. The catalyst body according to claim 17, wherein said microparticles are additionally joined to one another by oxygen binding.

19. The catalyst body according to claim 16, wherein said metallic active component is incorporated in said aluminum/silicon compound.

20. The catalyst body according to claim 16, wherein said metallic active component is a precious metal.

21. The catalyst body according to claim 20, wherein said precious metal is selected from the group consisting of Pt, Pd, Rh, and a mixture of at least two of Pt, Pd, and Rh.

22. The catalyst body according to claim 19, wherein said metallic active component is a precious metal.

23. The catalyst body according to claim 22, wherein said precious metal is selected from the group consisting of Pt, Pd, Rh, and a mixture of at least two of Pt, Pd, and Rh.

24. The catalyst body according to claim 16, wherein said aluminum/silicon compound is an aluminosilicate.

25. The catalyst body according to claim 24, wherein said aluminosilicate is a zeolite.

26. The catalyst body according to claim 25, wherein said zeolite is selected from the group consisting of a mordenite, a ZSM-5 zeolite, an H-zeolite, a USY-zeolite, and a beta zeolite.

27. The catalyst body according to claim 16, wherein said aluminum/silicon compound is a copper/silicon aluminophosphate.
